(19) United States
(12) Patent Application Publication
(10) Pub. No.: US 2025/0005704 A1
(43) Pub. Date: Jan. 2, 2025

(54) METHODS AND APPARATUS TO ANIMATE A SPLASH SCREEN

(71) Applicant: Texas Instruments Incorporated, Dallas, TX (US)

(72) Inventors: Sekhar Nori, Bangalore (IN); Vignesh Raghavendra, Bangalore (IN); Venkateswara Rao Mandela, Bangalore (IN)

(21) Appl. No.: 18/521,917

(22) Filed: Nov. 28, 2023

(30) Foreign Application Priority Data
Jun. 28, 2023 (IN) 202341043251

(51) Int. Cl. G06T 1/60; G06F 13/28

(52) U.S. Cl. CPC G06T 1/60; G06F 13/28

(57) ABSTRACT

Systems, apparatus, articles of manufacture, and methods to animate a splash screen are disclosed. An example apparatus includes a display controller; communication circuitry coupled to the display controller, memory controller circuitry configured to couple to a first memory and a second memory, and programmable circuitry coupled to the communication circuitry and the memory controller circuitry and configured to: receive an indication from the display controller to load a frame, in response to the indication from the display controller, cause the memory controller circuitry to copy the frame from the first memory to the second memory, update a frame pointer used by the display controller to reference the frame, and cause the display controller to output the frame to a display circuit.

### RELATED APPLICATIONS

This patent claims the benefit of India Provisional Patent Application No. 202341043251, which was filed on Jun. 28, 2023. India Provisional Patent Application No. 202341043251 is hereby incorporated herein by reference in its entirety. Priority to India Provisional Patent Application No. 202341043251 is hereby claimed.

### FIELD OF THE DISCLOSURE

This disclosure relates generally to splash screens and, more particularly, to methods and apparatus to animate a splash screen.

### BACKGROUND

Many computing systems display an image during a boot procedure. The display of the image provides information to a user so that the user knows that the system is functional and is loading. In various compute settings, there are requirements regarding the display of such splash screens. For example, in an automotive setting, a splash screen may need to be displayed within a certain time, e.g., five hundred milliseconds (ms) of an initial boot procedure.

### BRIEF DESCRIPTION OF THE DRAWINGS

FIG. 1 is a block diagram of an example environment in which an example animated splash screen system operates to cause display circuitry to present an animated splash screen while a main controller is initialized.

FIG. 2 is a block diagram of an example implementation of the animated splash screen system of FIG. 1.

FIG. 3 is a block diagram of an example implementation of the DMA controller of FIG. 2.

FIG. 4 is a flowchart representative of example machine readable instructions and/or example operations that may be executed, instantiated, and/or performed by programmable circuitry to display an animated splash screen.

FIG. 5 is a flowchart representative of example machine readable instructions and/or example operations that may be executed, instantiated, and/or performed by programmable circuitry to control operation of the display controller of FIG. 2.

FIG. 6 is a block diagram illustrating an example progression of frames that may be provided to the display controller by the DMA controller of FIG. 2.

FIG. 7 is another example block diagram illustrating an example progression of frames that may be provided to the display controller by the DMA controller of FIG. 2.

FIG. 8 is a block diagram illustrating an example progression through four frames.

FIG. 9 is a block diagram of an example processing platform including programmable circuitry structured to execute, instantiate, and/or perform the example machine readable instructions and/or perform the example operations of FIGS. 4 and/or 5 to implement the animated splash screen system 105 of FIG. 2.

FIG. 10 is a block diagram of an example implementation of the programmable circuitry of FIG. 9.

FIG. 11 is a block diagram of another example implementation of the programmable circuitry of FIG. 9.

The same reference numbers or other reference designators are used in the drawings to designate the same or similar (functionally and/or structurally) features.

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

### DETAILED DESCRIPTION

Splash screens are used across many different computing systems to inform a user that the computing system is functional. For example, during a boot procedure, a splash screen may be displayed to inform the user that the system is booting. Displaying such splash screens provides peace of mind to the user. In some examples, the user may wait longer before performing a corrective action to a system displaying a splash screen (e.g., pushing a “reset” button, removing and re-applying power, etc.), as compared to a system that does not utilize a splash screen. While static splash screens are beneficial, displaying an animated splash screen provides an added level of confidence to the user that the system is functioning properly.

In some settings, there are requirements for how quickly a computing system must perform various boot actions. For example, in an automotive setting, such computing systems have very stringent boot time requirements (e.g., 1-2 seconds from boot) for having the entire operating system (OS) stack operational. Moreover, sometimes there are requirements that a splash screen (e.g., an animated splash screen) must be displayed within the first two hundred milliseconds of the booting procedure.

Attempting both to boot an operating system and cause display of an animated splash screen within such timing requirements is a difficult task. For example, having a central processing unit of the computing system use resources to cause display the animated splash screen early during the boot procedure might delay booting of the entire OS, resulting in the overall boot time requirement not being met.

Example approaches disclosed herein utilize a system-on-a-chip (SoC) including a direct memory access (DMA) controller working in concert with a display controller to offload display of the animated splash screen while a central processing unit (CPU) of the computing system is booted. While examples disclosed herein are described in the context of offloading display of an animated splash screen while the CPU of the computing system is booted, such offloading may advantageously be performed at other times as well. For example, the animated splash screen system disclosed herein may be utilized during times when a user interface would otherwise not be expected to be interactable by a user. For example, while the CPU is performing an update, preparing information for display, etc., the animated splash screen system disclosed herein may be utilized.

Because there is also a limited amount of memory available for storage of frames of an animation, in examples disclosed herein, such frames are loaded from a storage media on demand and supplied to a display controller via a memory circuit. As a result, such approaches utilize minimal software intervention for refreshing and loading frames during booting. Moreover, such approaches utilize a small memory footprint, operating with a constrained memory buffer with a size of two to six (or more) frames.

Such approaches result in minimal setup overhead, so as to be able to be render animated splash screens quickly (e.g., within 200 ms of system startup).

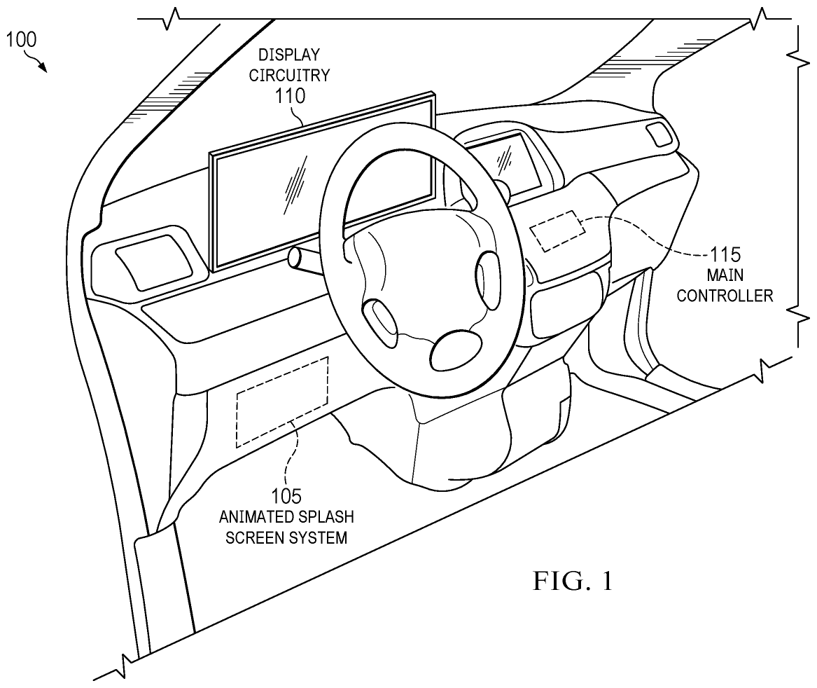

FIG. 1 is a block diagram of an example environment 100 in which an example animated splash screen system 105 operates to cause display circuitry 110 to present an animated splash screen while a main controller 115 is initialized. In the illustrated example of FIG. 1, the environment 100 is a vehicular environment. However, any other environment may alternatively be used. Example approaches disclosed herein are equally applicable to any computing system where a splash screen is displayed.

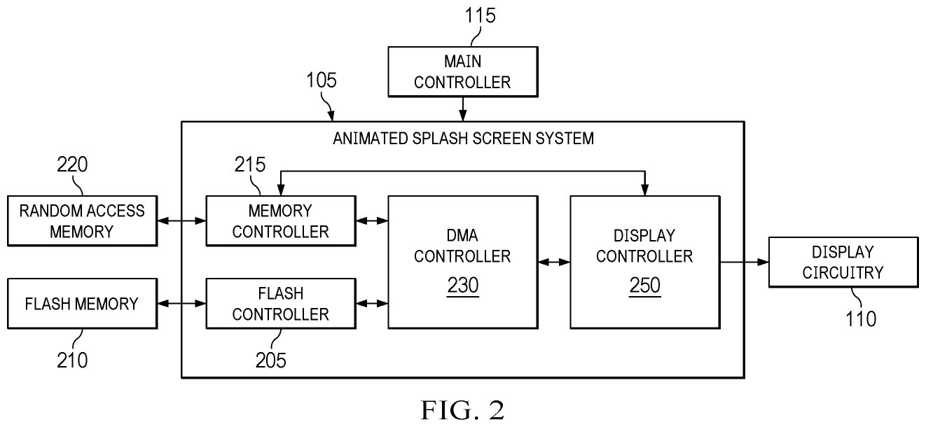

The example animated splash screen system 105 of the illustrated example of FIG. 1 presents an animated splash screen via the display 110, while the main controller 115 is initialized. An example implementation of the animated splash screen system 105 is described below in connection with FIG. 2.

The example display circuitry 110 of the illustrated example of FIG. 1 is implemented using a one or more display device (e.g., a light emitting diode (LED), an organic light emitting diode (OLED), a liquid crystal display (LCD), a cathode ray tube (CRT) display, an in-place switching (IPS) display, a touchscreen, etc). In the illustrated example of FIG. 1, a single display 110 is shown. However, in some examples, multiple display circuitries (e.g., display screens) may be used. Moreover, in some such examples, the animated splash screen may be presented on a single (e.g., first) display, while the other display(s) (e.g., a second display, a third display, etc.) may be used to present other information (or no information at all).

The example main controller 115 of the illustrated example of FIG. 1 is implemented by a general-purpose microprocessor (e.g., general-purpose microprocessor circuitry). In some examples, the example main controller 115 may be implemented within a same SoC as the animated splash screen system. The example main controller 115 may be initialized by a bootloader. The bootloader is circuitry that loads software (e.g., an image) into the main controller 115 (or a memory thereof) for execution. Such a bootloader may be highly optimized for image loading (e.g., to meet overall system booting requirements), and may not include capability for controlling display circuitry, such as the animated splash screen system 105. The example main controller 115 initializes the animated splash screen system 105 and/or other components of the example environment 100.

FIG. 2 is a block diagram of an example implementation of the animated splash screen system 105 of FIG. 1. The animated splash screen system 105 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the animated splash screen system 105 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example animated splash screen system 105 includes a flash controller 205 in communication with flash memory 210, a memory controller 215 in communication with random access memory 220, a direct memory access controller 230, and a display controller 250. The example DMA controller 230 facilitates movement of frames from the flash memory 210 to the random access memory 220 so that those frames may be accessed by the display controller 250 via the memory controller 215. The display controller 250 causes the frame(s) to be displayed by the display circuitry 110. As noted in connection with FIG. 1, the animated splash screen system 105 is implemented separately from the main controller 115 (e.g., a CPU).

The example flash controller 205 of the illustrated example of FIG. 2 is implemented by circuitry that enables interaction with the flash memory 210. While in the illustrated example of FIG. 2, the flash controller 205 interacts with flash memory, the example flash controller 205 may interact with memory implemented using any other type of memory technology. For example, the flash controller 205 may interact with a solid state drive or any other type of mass storage device.

The example memory controller 215 of the illustrated example of FIG. 2 is implemented by circuitry that enables interaction with the random access memory (RAM) 220. While in the illustrated example of FIG. 2 the memory controller 215 interacts with random access memory, the example memory controller 215 may interact with memory implemented using any other type of memory technology. For example, the example memory controller 215 may enable interaction with a volatile memory.

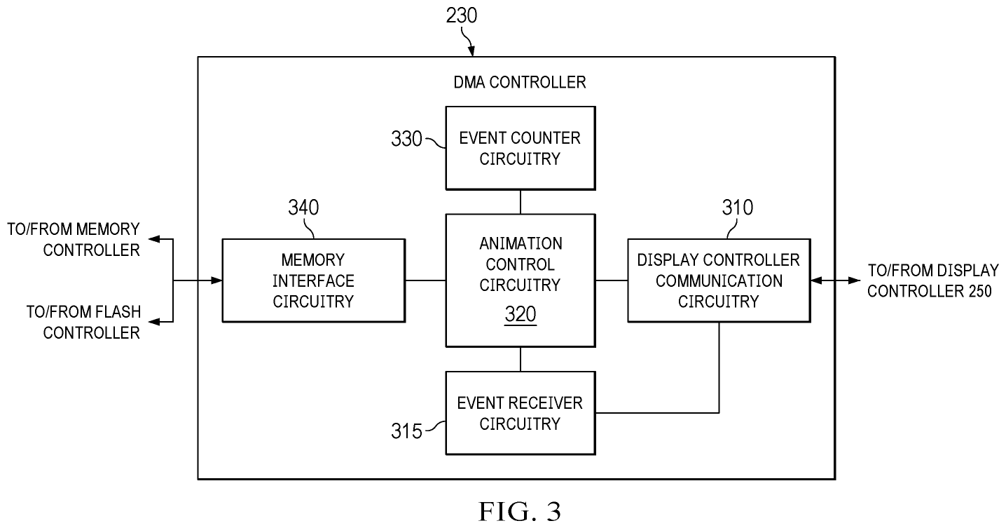

The example DMA controller 230 of the illustrated example of FIG. 2 is implemented by a direct memory access controller. In this manner, the DMA controller 230 allows for and/or orchestrates memory access operations. In some examples the DMA controller 230 may be implemented (e.g., programmed, designed, etc.) to execute particular functions such as, for example, movement of frames from flash memory to RAM for use by a display controller, controlling a frame index to be used by a display controller, indicating to a display controller that a frame is ready to be displayed, etc. In some examples, such functionality may be implemented using separate channels within the DMA controller 230. DMA channels are used to communicate data to and/or from memory. While communicating data to/from memory, processing tasks may be performed by the DMA controller 230. An example implementation of the DMA controller 230 is further described below in connection with FIG. 3.

The example display controller 250 of the illustrated example of FIG. 2 is implemented by circuitry that reads frames from memory (e.g., from the RAM 220) and causes the display circuitry 110 to display the frame. In some examples, the display controller 250 identifies the frame to be accessed from the RAM 220 based on an indication from the DMA controller 230. In examples disclosed herein, the display controller 250 provides an indication (e.g., a Vsync signal) to the DMA controller 230. Such an indication may be used to indicate that a current frame is displayed. However, such an indication may represent other event(s) within the display process. For example, the indication may be a vertical synchronization (Vsync) signal that is transmitted on a periodic basis (e.g., at a refresh rate of sixty hertz), the indication may be a signal representing that the display controller 250 has provided the frame to the display 110, etc.

While examples disclosed herein are described in the context of the display controller 250 reading one or more frames from the RAM 220, in some examples, the display controller 250 may read one or more frames from the flash memory 210. While accessing frames from the RAM 220 may be more time efficient, adequate performance may also be achieved by accessing those frames from the flash memory 210.

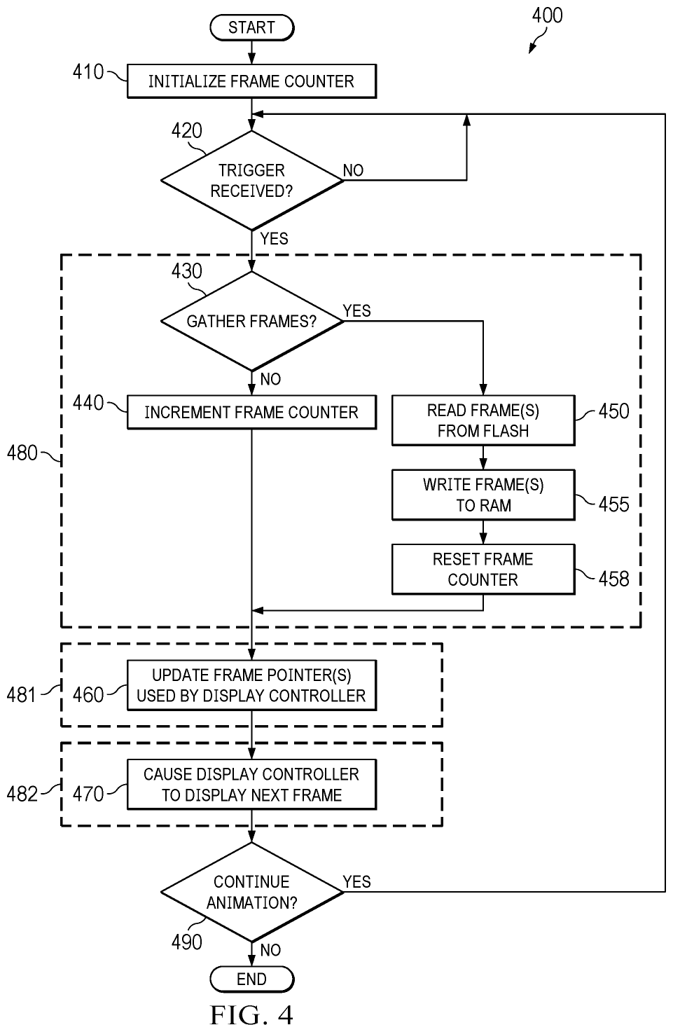

FIG. 3 is a block diagram of an example implementation of the DMA controller 230 of FIG. 2. The example DMA controller 230 of FIG. 2 includes display controller communication circuitry 310, event receiver circuitry 315, animation control circuitry 320, event counter circuitry 330, and memory interface circuitry 340. In some examples, the DMA controller 230 is instantiated by programmable circuitry executing DMA controller instructions and/or configured to perform operations such as those represented by the flowchart of FIG. 4.

The example display controller communication circuitry 310 of the illustrated example of FIG. 3 enables communication of information (e.g., notifications) to/from the display controller 250. In examples disclosed herein, the information received from the display controller 250 is passed to the event receiver circuitry 315. The example display controller communication circuitry 310 communicates information such as, for example, a “go” bit to the display controller 250, to indicate that a next frame is ready for display.

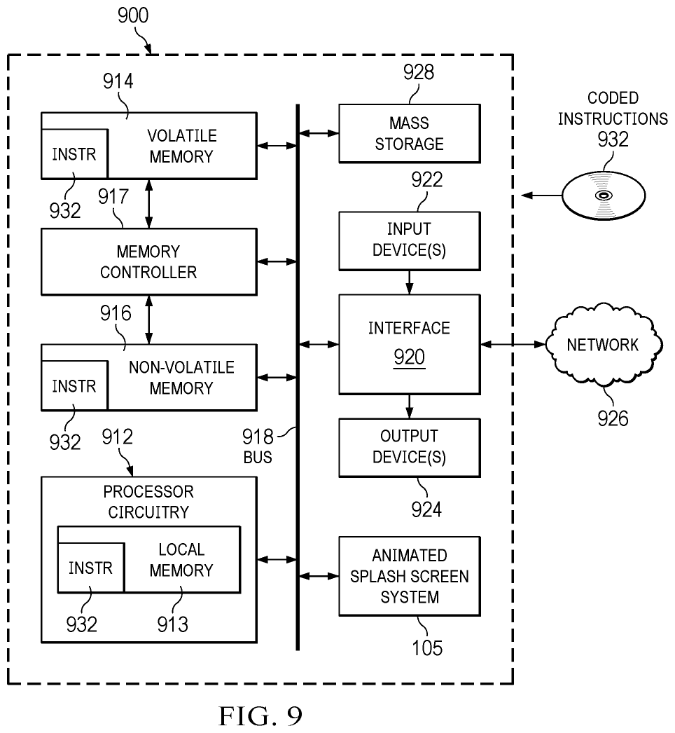

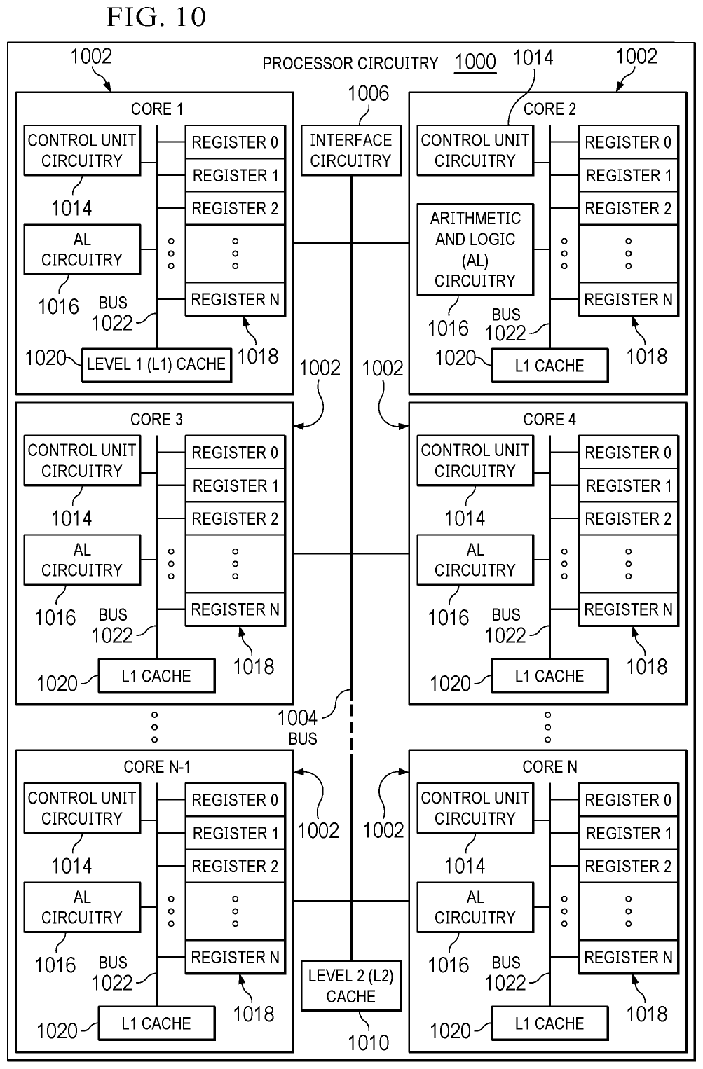

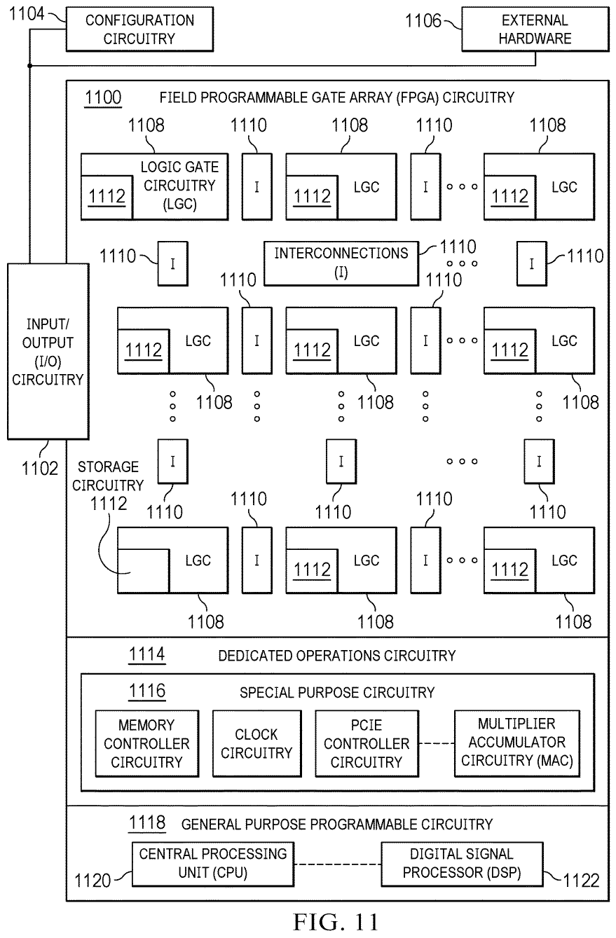

In some examples, the DMA controller 230 includes means for communicating with the display circuitry 110. For example, the means for communicating may be implemented by display controller communication circuitry 310. In some examples, the display controller communication circuitry 310 may be instantiated by programmable circuitry such as the example programmable circuitry 912 of FIG. 9. For instance, the display controller communication circuitry 310 may be instantiated by the example microprocessor 1000 of FIG. 10 executing machine executable instructions such as those implemented by at least block 470 of FIG. 4. In some examples, the display controller communication circuitry 310 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the display controller communication circuitry 310 may be instantiated by any other combination of hardware, software, and/or firmware. For example, the display controller communication circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example event receiver circuitry 315 of the illustrated example of FIG. 3 reviews events received via the display controller communication circuitry 310 to determine whether a trigger event has been received. For example, the display controller communication circuitry 310 may receive and relay a display trigger from the display controller 250. In examples disclosed herein, the display trigger represents a synchronization signal (e.g., a Vsync signal) received from the display controller 250.

In some examples, the DMA controller 230 includes means for receiving an event trigger. For example, the means for receiving may be implemented by event receiver circuitry 315. In some examples, the event receiver circuitry 315 may be instantiated by programmable circuitry such as the example programmable circuitry 912 of FIG. 9. For instance, the event receiver circuitry 315 may be instantiated by the example microprocessor 1000 of FIG. 10 executing machine executable instructions such as those implemented by at least block 420 of FIG. 4. In some examples, the event receiver circuitry 315 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the event receiver circuitry 315 may be instantiated by any other combination of hardware, software, and/or firmware. For example, the event receiver circuitry 315 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example animation control circuitry 320 of the illustrated example of FIG. 3, in response to the event receiver circuitry 315 determining that a trigger event has been received, evaluates whether frames are to be gathered. The animation control circuitry 320 determines whether frames are to be gathered by comparing the value of a frame counter (e.g., a counter stored in the event counter circuitry 330) to the frame count threshold. The frame counter stored in the event counter circuitry 330 represents a number of frames that have been presented since a last time that frames were populated into the RAM 220 for use by the display controller 250. The frame count threshold represents a number of frames that are to be presented before subsequent frames are populated into the RAM 220. If the value of the frame counter does not meet or exceed the frame count threshold, the animation control circuitry 320 increments the frame counter stored in the event counter circuitry 330. If the value of the frame counter meets or exceeds the frame count threshold, the animation control circuitry 320 causes frame(s) to be placed in the RAM 220 so that they can be used by the display controller 250. In this manner, after a threshold number of frames have been presented since the last time that frames were populated into the RAM 220, a subsequent group of frames is moved into the RAM 220 so that those subsequent frames may be presented, and the frame counter is reset. Resetting the frame counter enables the counting to continue for identification of when a second subsequent group of frames are to be moved into the RAM 220.

To accomplish the placement of the frame(s) into the RAM 220, the example animation control circuitry 320 instructs the memory interface circuitry 340 to read frame(s) from the flash memory 210 via the flash controller 205. The memory interface circuitry 340 then writes those frame(s) to the RAM 220 via the memory controller 215. In some examples, the animation control circuitry 320 and/or the memory controller 340 may apply a transformation and/or other modification to the frame(s) before writing the transformed/modified frame(s) to the RAM 220. For example, the animation control circuitry 320 and/or the memory controller 340 may decompress the frame(s) (e.g., if the frame(s) were stored in a compressed state in the flash memory 210), may re-size (e.g., crop, enlarge, shrink, etc.) the frame(s), etc.

In addition, the animation control circuitry 320 updates a frame pointer that is used by the display controller 250. The frame pointer instructs the display controller 250 as to where in the RAM 220 the next frame is stored. The example animation control circuitry 320 also instructs the display controller communication circuitry 310 to inform the display controller 250 that a subsequent frame is ready for display.

In some examples, the DMA controller 230 includes means for controlling animation. For example, the means for controlling may be implemented by animation control circuitry 320. In some examples, the animation control circuitry 320 may be instantiated by programmable circuitry such as the example programmable circuitry 912 of FIG. 9. For instance, the animation control circuitry 320 may be instantiated by the example microprocessor 1000 of FIG. 10 executing machine executable instructions such as those implemented by at least blocks 410, 430, 440, 458, 460 of FIG. 4. In some examples, the animation control circuitry 320 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the animation control circuitry 320 may be instantiated by any other combination of hardware, software, and/or firmware. For example, the animation control circuitry 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example event counter circuitry 330 of the illustrated example of FIG. 3 is implemented by a counter circuit capable of storing one or more count values. In examples disclosed herein, the event counter circuitry 330 may be implemented using a plurality of flip-flop circuits to enable storage of a value. However, in some examples, more complex circuitry such as, for example, memory circuitry may be used in place of the counter circuitry. In some examples, threshold values are also stored in the event counter circuitry 330.

In some examples, the DMA controller 230 includes means for counting events. For example, the means for counting may be implemented by event counter circuitry 330. In some examples, the event counter circuitry 330 may be instantiated by programmable circuitry such as the example programmable circuitry 912 of FIG. 9. In some examples, the event counter circuitry 330 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the event counter circuitry 330 may be instantiated by any other combination of hardware, software, and/or firmware. For example, event counter circuitry 330 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example memory interface circuitry 340 of the illustrated example of FIG. 3 reads one or more frames from the flash memory 210, and writes those one or more frames to the RAM 220 for use by the display controller 250. In this manner, the memory interface circuitry 340 interfaces with the flash controller 205 and/or the memory controller 215. In some examples the memory interface circuitry 340, perhaps aided by the animation control circuitry 320, modifies the frame read from the flash memory 210 before writing the modified frame to the RAM 220. For example, the animation control circuitry 320 and/or the memory controller 340 may decompress the frame(s) (e.g., if the frame(s) were stored in a compressed state in the flash memory 210), may re-size (e.g., crop, enlarge, shrink, etc.) the frame(s), etc.

In some examples, the DMA controller 230 includes means for interfacing with the memory controller 215 and/or the flash controller 205. For example, the means for interfacing may be implemented by memory interface circuitry 340. In some examples, the memory interface circuitry 340 may be instantiated by programmable circuitry such as the example programmable circuitry 912 of FIG. 9. For instance, the memory interface circuitry 340 may be instantiated by the example microprocessor 1000 of FIG. 10 executing machine executable instructions such as those implemented by at least blocks 450, 455 of FIG. 4. In some examples, the memory interface circuitry 340 may be instantiated by hardware logic circuitry, which may be implemented by an ASIC. XPU, or the FPGA circuitry 1100 of FIG. 11 configured and/or structured to perform operations corresponding to the machine-readable instructions. Additionally or alternatively, the memory interface circuitry 340 may be instantiated by any other combination of hardware, software, and/or firmware. For example, the memory interface circuitry 340 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the animated splash screen system 105 of FIG. 1 is illustrated in FIG. 2, one or more of the elements, processes, and/or devices illustrated in FIG. 2 may be combined, divided, re-arranged, omitted, eliminated, and/or implemented in any other way. Further, the example flash controller 205, the example memory controller 215, the example DMA controller 230, the example display controller 250 and/or, more generally, the example animated splash screen system 105 of FIG. 2, may be implemented by hardware alone or by hardware in combination with software and/or firmware. Thus, for example, any of the example flash controller 205, the example memory controller 215, the example DMA controller 230, the example display controller 250, and/or, more generally, the example animated splash screen system 105, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example animated splash screen system 105 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the animated splash screen system 105 of FIG. 2 and/or representative of example operations which may be performed by programmable circuitry to implement and/or instantiate the animated splash screen system 105 of FIG. 2, are shown in FIGS. 4 and/or 5. The machine readable instructions may be one or more executable programs or portion(s) of one or more executable programs for execution by programmable circuitry such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4 and/or 5, many other methods of implementing the example animated splash screen system 105 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine readable instructions and/or the corresponding program(s) can be executed in whole or in part. Thus, machine readable, computer readable and/or machine-readable media, as used herein, may include instructions and/or program(s) regardless of the particular format or state of the machine readable instructions and/or program(s).

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 4 and/or 5 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed, instantiated, and/or performed by programmable circuitry to display an animated splash screen. The example machine-readable instructions and/or the example operations 400 of FIG. 4 may begin upon system initialization (e.g., upon application of power to the circuitry, upon receiving a start command from a user, etc.).

The animation control circuitry 320 initializes a frame counter stored in the event counter circuitry 330. (Block 410). The frame counter is used to determine whether additional frames should be retrieved from the flash memory 210 and stored in the random access memory 220 for use by the display controller 250. In the illustrated example of FIG. 3, the frame counter is initialized to a value larger than a threshold frame count. Initializing to the value larger than the threshold frame count ensures that frames will be moved upon receipt of an initial trigger from the display controller 250.

The event receiver circuitry 315 then waits for a trigger event to be received from the display controller 250. (Block 420). In examples disclosed herein, the trigger event represents receipt of a synchronization signal (e.g., a Vsync signal) received from the display controller 250. If no trigger event is detected, the event receiver circuitry 315 continues to wait for a trigger event.

Once the trigger is received (e.g., block 420 returns a result of YES), the animation control circuitry 320 evaluates whether frames are to be gathered. The animation control circuitry 320 determines whether frames are to be gathered by comparing the value of the frame counter to the frame count threshold. (Block 430). If the value of the frame counter does not meet or exceed the frame count threshold (e.g., block 430 returns a result of NO), the animation control circuitry 320 increments the frame counter stored in the event counter circuitry 330. (Block 440). If the value of the frame counter meets or exceeds the frame count threshold (e.g., block 430 returns a result of YES), the animation control circuitry 320 causes frames to be placed in the RAM 220 so that they can be used by the display controller 250.

To accomplish the placement of the frame(s) into the RAM 220, the example animation control circuitry 320 instructs the memory interface circuitry 340 to read frame(s) from the flash memory 210 via the flash controller 205. (Block 450). The memory interface circuitry 340 then writes those frame(s) to the RAM 220 via the memory controller 215. (Block 455). In some examples, the animation control circuitry 320 and/or the memory controller 340 may apply a transformation and/or other modification to the frame(s) before writing the transformed/modified frame(s) to the RAM 220. For example, the animation control circuitry 320 and/or the memory controller 340 may decompress the frame(s) (e.g., if the frame(s) were stored in a compressed state in the flash memory 210), may re-size (e.g., crop, enlarge, shrink, etc.) the frame(s), etc.

In examples disclosed herein, the number of frames written to the RAM 220 is equal to the frame count threshold. That is, after display of a number of frames equal to the frame count threshold, the next number of frames equal to the frame count threshold are moved into the RAM 220. However, in some examples, a number of frames greater than the frame count threshold may be moved into the RAM 220. In some examples, the number of frames may be based on whether any frames had been previously moved into the RAM 220 (e.g., is this the first iteration of the process of FIG. 4). Writing a number of frames greater than the frame count threshold in the initial iteration of the process of FIG. 4 helps to ensure that frames are available for use by the display controller 250, even though frames are not written to the RAM 220 after every triggering event.

After writing the frame(s) to the RAM 220, the animation control circuitry 320 then resets the frame counter. (Block 458). Resetting the frame counter ensures that frames are only written to the RAM 220 periodically.

The example animation control circuitry 320 then updates a frame pointer that is used by the display controller 250 to read the frame from the RAM 220. (Block 460).

The example display controller communication circuitry 310 then causes the display controller to display the next frame. (Block 470). Causing the display controller to display the next frame is implemented by setting a go bit of the display controller 250. The display controller monitors the value of the go bit to determine whether to proceed with reading and displaying the next frame.

As illustrated in the example of FIG. 4, the operations performed by the DMA controller 230 can be logically organized into three separate groups 480, 481, 482. The first group 480 represents operations to place the appropriate frames into the RAM 220 for use by the display controller 250 (e.g., blocks 430, 440, 450, 455, 458). The second group 481 represents operations to inform the display controller 250 of the address of the next frame to be displayed (e.g., block 460). The third group 482 represents operations to cause the display controller to display the next frame (e.g., block 470). While in the illustrated example of FIG. 4, such groups of operations are illustrated in a serial manner, in some examples, these groups of operations may be performed in a parallel manner. For example, each group of operations may be performed by separate channels of the animation control circuitry 320 and/or, more generally, the DMA controller 230. In this manner, the example DMA controller 230 includes at least three channels that each perform a corresponding group of operations. For example, a first channel may perform the first group of operations 480, a second channel may perform the second group of operations 481, and a third channel may perform the third group of operations 482.

After the operations of the groups 480, 481, 482 are complete, the example animation controller circuitry 320 determines whether to continue the animation. (Block 490). The determination of whether to continue the animation may be based on, for example, whether a threshold amount of time has elapsed (e.g., when the animation is to be displayed for a threshold amount of time such as, for example, two seconds) whether a boot procedure of the main controller 115 has completed, etc. If animation is to continue (e.g., block 490 returns a result of YES), control returns to block 420, where the event receiver circuitry 315 awaits a further trigger. If animation is not to continue (e.g., block 490 returns a result of NO), the example process 400 of FIG. 4 terminates.

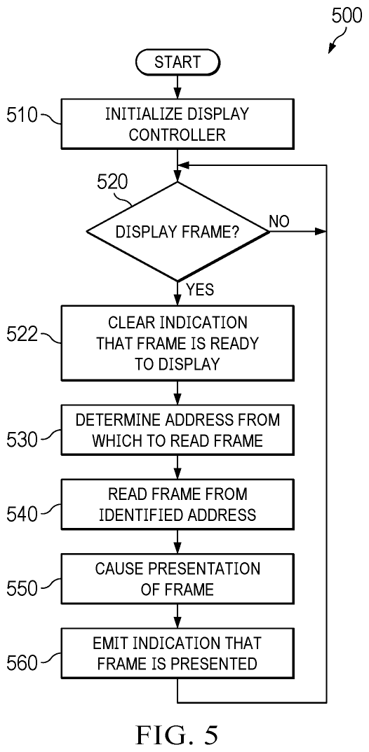

FIG. 5 is a flowchart representative of example machine readable instructions and/or example operations 500 that may be executed, instantiated, and/or performed by programmable circuitry to control operation of the display controller 250 of FIG. 2. The example machine-readable instructions and/or the example operations 500 of FIG. 5 begins upon system initialization (e.g., upon application of power to the circuitry, upon receiving a start command from a user, etc.). Upon startup, the display controller 250 becomes initialized. (Block 510).

The display controller 250 determines whether to display a frame. (Block 520). In some examples, the determination of whether to display a frame is based on the value of the “go” bit, which is initially set by the display controller communication circuitry 310 and subsequently cleared by the display controller 250. If the “go” bit is not set, indicating that a frame is not ready, control returns to block 520, where the display controller 250 continues to determine whether to display a frame. In some examples, the display controller 250 waits before performing a next determination of whether to display a frame. In some examples, upon a first iteration of the process of FIG. 5, the example display controller 250 does not wait for an indication of whether the “go” bit is set.

If the display controller 250 determines that a frame is to be displayed (e.g., block 520 returns a result of YES), the example display controller clears the indication that a frame is ready to display (Block 522). In this manner, display controller 250 clears the “go” bit, so that the display controller communication circuitry 310 may subsequently set the go bit.

The example display controller 250 then determines the memory address from which to read the frame. (Block 530). In examples disclosed herein, the memory address represents an address in the RAM 220 (e.g., where the DMA controller 230 stored the next frame). The display controller 250 then reads the frame from the identified memory address (Block 540). The display controller 250 causes the display circuitry 110 to display the frame. (Block 550). The display controller 250 then emits an indication that the frame has been presented. (Block 560). In examples disclosed herein, the indication that is emitted is a Vsync signal. However, any other type of indication may additionally or alternatively be used.

The example process then loops back to block 520, where, upon detection of a subsequent “go” bit being set, a subsequent frame is displayed by the display controller 250. The example process continues until, for example, the main processor is booted.

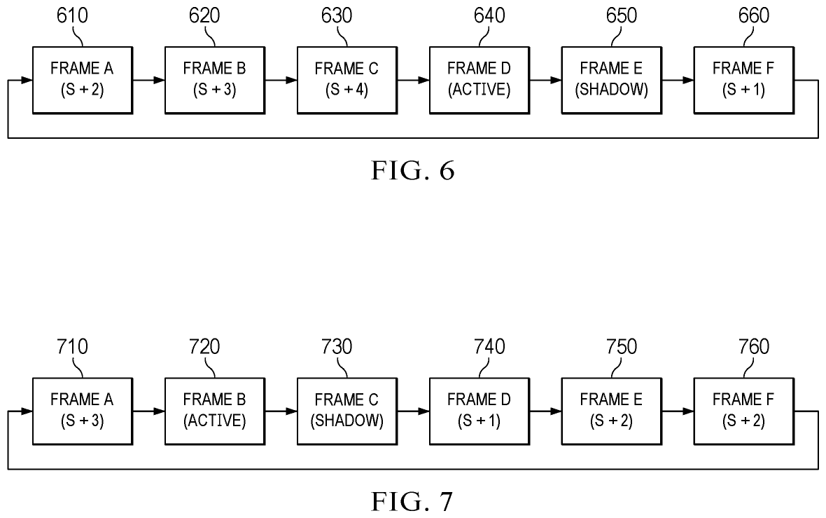

FIG. 6 is a block diagram illustrating an example progression of frames that may be provided to the display controller 250 by the DMA controller 230. In the illustrated example of FIG. 6, six frames 610, 620, 630, 640, 650, 660 are shown. A fourth frame 640 represents a frame actively being displayed by the display controller 230. A fifth frame 650 represents a shadow frame that is to be subsequently displayed by the display controller 230. As used herein, a shadow frame is a frame that is to be displayed after a current frame is displayed. In some examples, a shadow frame (or a memory address of the shadow frame) is stored in a shadow register to be used by the display controller 250. A sixth frame 660 represents a subsequent frame to be displayed after the fifth frame 650 is displayed. After displaying the sixth frame 660, the DMA controller 230 causes the first frame 610 to be the next frame to be displayed. In this manner, the sequence of frames is represented by a circular buffer. After the first frame 610 is displayed, a second frame 620 is displayed, and then a third frame 630 is displayed. While the frame index is incremented through (e.g., around) the circular buffer, the actual frame data stored for each non-displayed frame may be updated.

FIG. 7 is another example block diagram illustrating an example progression of frames that may be provided to the display controller 250 by the DMA controller 230. In the illustrated example of FIG. 7, six frames 710, 720, 730, 740, 750, 760 are shown. A third frame 730 represents a frame actively being displayed by the display controller 230. A fourth frame 740 represents a shadow frame that is to be subsequently displayed by the display controller 230. A fifth frame 750 represents a subsequent frame to be displayed after the fourth frame 740 is displayed, and then a sixth frame 760 is displayed. After displaying the sixth frame 760, the DMA controller 230 causes the first frame 710 to be the next frame to be displayed. After the first frame 710 is displayed, the second frame 720 is displayed, etc. While the frame index is incremented through (e.g., around) the circular buffer, the actual frame data stored for each non-displayed frame may be updated.

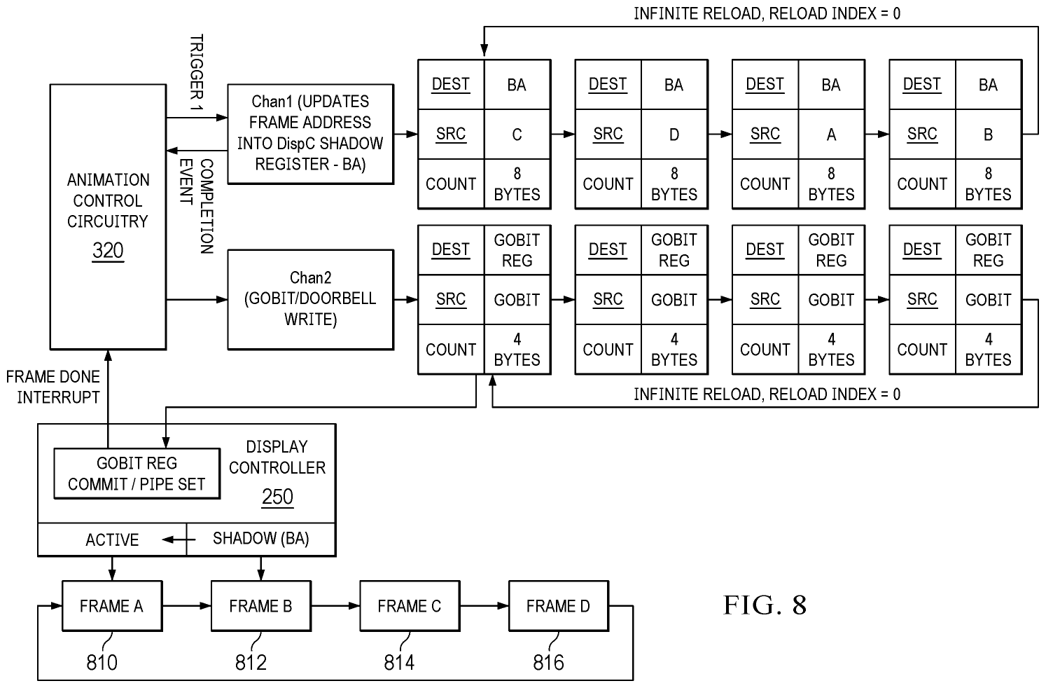

FIG. 8 is a block diagram illustrating an example progression through four frames 810, 812, 814, 816. While in the illustrated example of FIGS. 6 and/or 7, a circular buffer having six frames is illustrated, in some examples, a different number of frames may be used. For example, in the illustrated example of FIG. 8, four frames are shown 810, 812, 814, 816. The illustrated example of FIG. 8 illustrates how the display controller 250 monitors the “go” bit written to the memory using a second channel (illustrated as Chan2) of the DMA controller at the direction of the animation control circuitry 320. The display controller 250 provides an indication to the animation control circuitry 320 of the DMA controller, in the form of a frame done interrupt to inform the animation control circuitry 320 that the current frame has been displayed. This notification to the animation control circuitry 320 causes the animation control circuitry 320 to (using a first channel, labeled Chan1) update a frame address into a shadow register of the display controller 250. As noted above, the shadow register identifies the memory address of the subsequent frame to be displayed. In the illustrated example of FIG. 8, the acronym BA represents a base address.

FIG. 9 is a block diagram of an example programmable circuitry platform 900 structured to execute and/or instantiate the example machine-readable instructions and/or the example operations of FIGS. 4 and/or 5 to implement the animated splash screen system 105 of FIG. 2. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIGS. 4 and/or 5, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 4 and/or 5 to effectively instantiate the circuitry of FIG. 2 as logic circuits to perform operations corresponding to those machine-readable instructions. In some such examples, the circuitry of FIG. 2 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine-readable instructions and/or operations represented by the flowcharts of FIGS. 4 and/or 5.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine-readable instructions. However, once configured, the FPGA circuitry 1100 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine readable instructions represented by the flowchart(s) of FIGS. 4 and/or 5 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4 and/or 5. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4 and/or 5. As such, the FPGA circuitry 1100 may be configured and/or structured to effectively instantiate some or all of the operations/functions corresponding to the machine readable instructions of the flowchart(s) of FIGS. 4 and/or 5 as dedicated logic circuits to perform the operations/functions corresponding to those software instructions in a dedicated manner analogous to an ASIC. Therefore, the FPGA circuitry 1100 may perform the operations/functions corresponding to the some or all of the machine-readable instructions of FIGS. 4 and/or 5 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine-readable instructions of FIGS. 4 and/or 5 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 10. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine readable instructions represented by the flowchart(s) of FIGS. 4 and/or 5 to perform first operation(s)/function(s), the FPGA circuitry 1100 of FIG. 11 may be configured and/or structured to perform second operation(s)/function(s) corresponding to a second portion of the machine readable instructions represented by the flowcharts of FIG. 4 and/or 5, and/or an ASIC may be configured and/or structured to perform third operation(s)/function(s) corresponding to a third portion of the machine readable instructions represented by the flowcharts of FIGS. 4 and/or 5.

It should be understood that some or all of the circuitry of FIG. 2 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1000 of FIG. 10 may execute machine readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 2 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Numerical identifiers such as “first,” “second,” “third,” etc. are used merely to distinguish between elements of substantially the same type in terms of structure and/or function. These identifiers, as used in the detailed description, do not necessarily align with those used in the claims.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means +/−10 percent of the stated value, or, if the value is zero, a reasonable range of values around zero.

Modifications are possible in the described embodiments, and other embodiments are possible, within the scope of the claims.

From the foregoing, it will be appreciated that example systems, apparatus, articles of manufacture, and methods have been disclosed that enable efficient animation of splash screens. Disclosed systems, apparatus, articles of manufacture, and methods improve the efficiency of using a computing device by offloading the display of a splash screen from a main controller (e.g., a main CPU) to a SoC. Such offloading enables the main controller to efficiently be booted without the need to expend resources on display of a splash screen. Disclosed systems, apparatus, articles of manufacture, and methods are accordingly directed to one or more improvement(s) in the operation of a machine such as a computer or other electronic and/or mechanical device.

It is noted that this patent claims priority from India Provisional Patent Application No. 202341043251, which was filed on Jun. 28, 2023, and is hereby incorporated by reference in its entirety.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
a display controller;
communication circuitry coupled to the display controller;
memory controller circuitry configured to couple to a first memory and a second memory; and
programmable circuitry coupled to the communication circuitry and the memory controller circuitry and configured to:
receive an indication from the display controller to load a frame;
in response to the indication from the display controller, cause the memory controller circuitry to copy the frame from the first memory to the second memory;
update a frame pointer used by the display controller to reference the frame; and
cause the display controller to output the frame to a display circuit.

2. The apparatus of claim 1, wherein the programmable circuitry is configured to copy the frame from the first memory to the second memory in response to a determination that a frame counter meets or exceeds a frame counter threshold.

3. The apparatus of claim 2, wherein the programmable circuitry is configured to, in response to a determination that the frame counter has not reached the frame counter threshold, increment the frame counter.

4. The apparatus of claim 1, wherein the first memory is a flash memory and the second memory is a random access memory.

5. The apparatus of claim 1, wherein the display controller is configured to access the frame from the second memory.

6. The apparatus of claim 1, wherein the programmable circuitry is implemented using a direct memory access controller.

7. The apparatus of claim 6, wherein the direct memory access controller is configured to copy the frame from the first memory to the second memory using a first channel, the direct memory access controller is configured to update the frame pointer using a second channel, and the direct memory access controller is configured to cause the display controller to output the frame using a third channel.

8. The apparatus of claim 1, wherein the indication from the display controller is a vertical synchronization signal.

9. A direct memory access controller comprising:
memory interface circuitry configured to couple to a first memory and a second memory, the first memory configured to store frames for display by a display controller, the display controller configured to access the frames from the second memory;
event receiver circuitry configured to receive an indication from the display controller;
animation control circuitry coupled to the memory interface circuitry and the event receiver circuitry and configured to, in response to the indication from the display controller, cause the memory interface circuitry to read a frame from the first memory and write the frame to the second memory; and
communication circuitry configured to update a frame pointer used by the display controller to reference the frame, and cause the display controller to output the frame to a display.

10. The direct memory access controller of claim 9, wherein the indication from the display controller is a vertical synchronization signal.

11. The direct memory access controller of claim 9, wherein the first memory is a flash memory and the second memory is a random access memory.

12. The direct memory access controller of claim 9, wherein the memory interface circuitry is configured to, in response to a determination that a frame counter meets or exceeds a frame counter threshold, read the frame from the first memory, and write the frame to the second memory.

13. The direct memory access controller of claim 12, wherein the animation control circuitry is configured to, in response to a determination that the frame counter does not meet or exceed the frame counter threshold, increment the frame counter.

14. The direct memory access controller of claim 12, wherein the animation control circuitry is configured to modify the frame prior to the memory interface circuitry writing the frame to the second memory.

15. A method comprising:
receiving an indication from a display controller;
in response to the indication from the display controller, causing a frame to be copied from a first memory to a second memory;
updating a frame pointer used by the display controller to reference the frame; and
causing the display controller to output the frame to a display.

16. The method of claim 15, wherein the frame is copied from the first memory to the second memory in response to a determination that a frame counter meets or exceeds a frame counter threshold.

17. The method of claim 16, further comprising incrementing the frame counter in response to a determination that the frame counter does not meet or exceed the frame counter threshold.

18. The method of claim 15, wherein the copying of the frame from the first memory to the second memory includes reading the frame from the first memory and writing the frame to the second memory.

19. The method of claim 18, further including modifying the frame prior to writing the modified frame to the second memory.

20. The method of claim 15, wherein the indication from the display controller is a vertical synchronization signal.
